(19) United States
(12) Patent Application Publication
(10) Pub. No.: US 2010/0052980 A1
(43) Pub. Date: Mar. 4, 2010

(54) DATA COMPRESSING METHOD, DATA PROVIDING METHOD, AND DATA COMPRESSING DEVICE

(75) Inventor: Kyoichi TOMITA, Yokohama-shi (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/547,754

(22) Filed: Aug. 26, 2009

(30) Foreign Application Priority Data
Sep. 2, 2008 (JP) 2008-225064

(51) Int. Cl. G01S 5/14

(52) U.S. Cl. 342/357.03

(57) ABSTRACT

A data compressing method includes: calculating prediction orbit data of a plurality of positioning satellites moving along predetermined orbits around the earth by using prediction positions of the plural positioning satellites; calculating differences between standard orbit data as standard for the predetermined orbits around the earth and the prediction orbit data of the plural positioning satellites; and storing the differences.

The entire disclosure of Japanese Patent Application No. 2008-225064, filed Sep. 2, 2008 is expressly incorporated by reference herein.

### BACKGROUND

1. Technical Field

The present invention relates to a data compressing method, a data providing method, a data restoring method, a data compressing device, and a positioning device.

2. Related Art

Currently, GPS (global positioning system) is widely known as a positioning system using positioning signals, and is included in a positioning device contained in a cellular phone, a car navigation, or other apparatus. The GPS measures positions by performing positioning calculation to obtain four parameters of three-dimensional coordinates indicating the position of the GPS and time error based on information such as the positions of plural GPS satellites and the pseudo distances between the respective GPS satellites and the GPS.

According to the positioning method by the GPS, the satellite information such as positions, speeds, and moving directions of the GPS satellites is obtained based on navigation data such as almanac and ephemeris superimposed on GPS satellite signals transmitted from the GPS satellites, and positioning calculation is performed using the satellite information and time information. Ephemeris is particularly effective information for capturing satellites. Thus, when positioning is started without ephemeris, a long time is required for time to first fix (TTFF). Even in the case other than TTFF, the time for capturing a satellite for the first time considerably varies depending on whether ephemeris of the corresponding satellite has been obtained or not.

International Publication No. 2006/031652 pamphlet discloses a technology of a server client system which predicts ephemeris for a long period such as one week using a server and provides the prediction ephemeris (hereinafter referred to as “long-term prediction ephemeris” (long-term satellite orbit almanac)) to a positioning device as a client.

The long-term prediction ephemeris is long-term (such as one week) data about predicted satellite orbits for all of GPS satellites. In this case, the amount of data becomes larger than that of ephemeris for one satellite. It is expected that the long-term prediction ephemeris is downloaded to the positioning device from the server system. Thus, there is a demand for reducing the amount of data about the long-term prediction ephemeris as much as possible so as to lower the communication cost associated with communication time and communication volume.

### SUMMARY

It is an advantage of some aspects of the invention to provide a new technology for reducing the amount of ephemeris data to be supplied to a positioning device.

A first aspect of the invention is directed to a data compressing method including: calculating prediction orbit data of a plurality of positioning satellites moving along predetermined orbits around the earth by using prediction positions of the plural positioning satellites; calculating differences between standard orbit data as standard for the predetermined orbits around the earth and the prediction orbit data of the plural positioning satellites; and storing the differences.

As another aspect of the invention, the first aspect can be configured as a data compressing device including: a prediction orbit data calculating unit which calculates prediction orbit data of a plurality of positioning satellites moving along predetermined orbits around the earth by using prediction positions of the plural positioning satellites; a difference calculating unit which calculates differences between standard orbit data as standard for the predetermined orbits around the earth and the prediction orbit data of the plural positioning satellites; and a difference storing unit which stores the differences.

According to the structures of the aspects of the invention, the prediction orbit data of the plural positioning satellites moving along the predetermined orbits around the earth are calculated based on the prediction positions of the plural positioning satellites. Then, the differences between the standard orbit data as the standard of the predetermined orbits around the earth and the prediction orbit data of the plural positioning satellites are calculated, and the differences thus calculated are stored.

The positioning satellites moving along the predetermined orbits around the earth do not necessarily move along the same orbit without any difference due to disturbance. The positioning satellites are only controlled in such a manner as to move along the predetermined orbits around the earth as much as possible. Thus, the actual orbits are slightly different every time the positioning satellites move along the orbits. In this case, the data amount of the difference between the standard orbit data as the standard of the predetermined orbits around the earth and the prediction orbit data of the prediction orbits along which the positioning satellites may actually move is considerably smaller than the data amount of the prediction orbit data. Thus, reduction of the communication cost such as communication time and communication volume and reduction of the memory capacity necessary for data storage can be achieved by storing the difference between the standard orbit data and prediction orbit data.

A second aspect of the invention is directed to the data compressing method of the first aspect, wherein the predetermined orbits around the earth contain a plurality of orbits having different inclination angles with respect to the earth, along which orbits the plural positioning satellites move, and that the data compressing method further includes calculating the standard orbit data of the plural orbits based on one basic orbit of the plural orbits and the inclination angles.

According to this structure, the standard orbit data of the plural orbits is calculated based on one basic orbit of the plural orbits and the inclination angles of the plural orbits with respect to the earth. Thus, the standard orbit data can be easily obtained by calculating other orbits based on the one orbit as the basic orbit, and the necessity for storing the respective orbit data can be eliminated.

A third aspect of the invention is directed to the data compressing method of the first or second aspect, wherein the data compressing method further includes calculating reference orbit data of the plural positioning satellites based on the prediction positions of the plural positioning satellites. In this case, the differences are calculated using the reference orbit data as the standard orbit data.

According to this structure, reference orbit data of the plural positioning satellites is calculated based on the prediction positions of the plural positioning satellites. Also, the differences are calculated using the reference orbit data as the standard orbit data. In this case, the difference between the reference orbit data and the prediction orbit data can be reduced by using an average orbit of the plural positioning satellites as the reference orbit data, for example. As a result, the data amount can be decreased.

A fourth aspect of the invention is directed to the data compressing method of any of the first to third aspects, wherein the prediction orbit data is calculated for each of predetermined unit terms. The differences are calculated for each of the predetermined unit terms. The differences are stored using substitute data containing the differences of the plural positioning satellites for each of the predetermined unit terms instead of long-term satellite orbit almanac data containing the prediction orbit data of the plural positioning satellites for each of the predetermined unit terms.

According to this structure, the predetermined orbit data is calculated for each of the predetermined unit terms, and the differences are calculated for each of the predetermined unit terms. Then, the substitute data containing the differences of the plural positioning satellites for each of the predetermined unit terms is stored instead of the long-term satellite orbit almanac data containing the prediction orbit data of the plural positioning satellites for each of the predetermined unit terms. The amount of the satellite orbit almanac data increases as the period of the data becomes longer. However, the data amount can be reduced by storing the substitute data which contains the differences.

A fifth aspect of the invention is directed to a data providing method providing the substitute data calculated by the data compressing method of the fourth aspect instead of the long-term satellite orbit almanac data.

According to this structure, communication cost such as communication time and communication volume can be considerably reduced by providing the substitute data instead of the long-term satellite almanac data.

A sixth aspect of the invention is directed to a data restoring method restoring the prediction orbit data of the positioning satellites based on the differences of the positioning satellites and the standard orbit data calculated by the compressing method of any of the first to fourth aspects.

The aspect of the invention can be configured as a positioning device restoring the prediction orbit data of the positioning satellites based on the differences and the standard orbit data of the positioning satellites calculated by the data compressing method of any of the first to fourth aspects to use the prediction orbit data for positioning.

According to the aspects of the invention, prediction orbit data of the positioning satellites can be restored and used based on the differences and standard orbit data of the positioning satellites.

### BRIEF DESCRIPTION OF THE DRAWINGS

The invention will be described with reference to the accompanying drawings, wherein like numbers reference like elements.

FIG. 1 illustrates a general structure of a positioning system.

FIG. 2 illustrates a principle for producing compressed long-term prediction ephemeris.

FIG. 3 illustrates the principle for producing compressed long-term prediction ephemeris.

FIG. 4 illustrates the principle for producing compressed long-term prediction ephemeris.

FIG. 5 illustrates the principle for producing compressed long-term prediction ephemeris.

FIG. 6 is a block diagram showing a function structure of a server system.

FIG. 7 shows an example of data stored in a ROM of the server system.

FIG. 8 shows an example of data stored in a hard disk of the server system.

FIG. 9 shows an example of data structure of satellite prediction almanac.

FIG. 10 shows an example of data structure of compressed long-term prediction ephemeris data.

FIG. 11 shows an example of data structure of reference orbit disposition structure parameter data.

FIG. 12 shows an example of data structure of reference orbit satellite initial position data.

FIG. 13 shows an example of data structure of compressed prediction ephemeris.

FIG. 14 is a flowchart showing flow of compressed long-term prediction ephemeris providing process.

FIG. 15 is a flowchart showing flow of compressed long-term prediction ephemeris producing process.

FIG. 16 is a flowchart showing flow of the compressed long-term prediction ephemeris producing process.

FIG. 17 is a block diagram showing a function structure of a cellular phone.

FIG. 18 shows an example of data stored in a ROM of the cellular phone.

FIG. 19 shows an example of data stored in a flash ROM of the cellular phone.

FIG. 20 shows an example of data stored in a RAM of the cellular phone.

FIG. 21 is a flowchart showing flow of a main process.

FIG. 22 is a flowchart showing flow of an initial positioning speed increase process.

FIG. 23 is a flowchart showing flow of a second initial positioning speed increase process.

FIG. 24 shows an example of data structure of second compressed long-term prediction ephemeris data.

### DESCRIPTION OF EXEMPLARY EMBODIMENT

A preferred embodiment according to the invention is hereinafter described with reference to the drawings. The invention is not limited to the embodiment described herein.

### 1. SYSTEM STRUCTURE

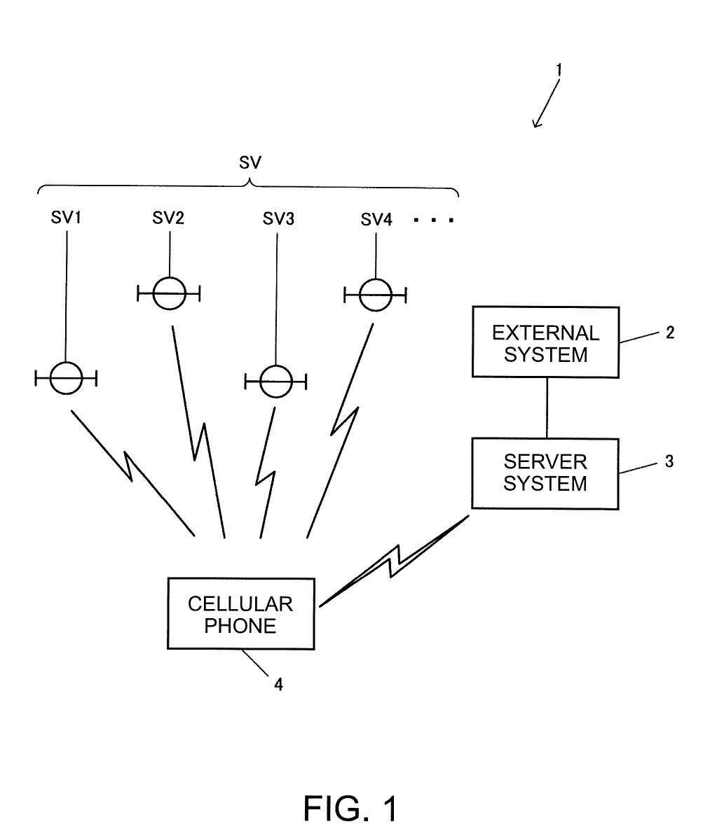

FIG. 1 illustrates a general structure of a positioning system 1 according to this embodiment. The positioning system 1 includes an external system 2, a server system 3, a cellular phone 4 as an electronic device having a positioning device, and a plurality of GPS satellites SV (SV1, SV2, SV3, SV4 and others).

The external system 2 is a system which periodically receives satellite signals from the GPS satellites SV, produces satellite prediction almanac based on navigation data and the like contained in the satellite signals, and supplies the satellite prediction almanac to the server system 3. The satellite prediction almanac provided by the external system 2 is a group of discrete data indicating predicted future positions of the respective GPS satellites SV and disposed in time series as discontinuous position data. The external system 2 corresponds to a computer system of a private or public organization providing satellite prediction almanac, for example.

The server system 3 is a system including a server which obtains satellite prediction almanac from the external system 2, and produces and provides prediction ephemeris for all of the GPS satellites SV effective for a long period of at least one day such as one week (hereinafter referred to as “long-term prediction ephemeris (long-term satellite orbit almanac)”) by using the satellite prediction almanac received from the external system 2.

According to this embodiment, the server system 3 produces long-term prediction ephemeris not in the form of original values of satellite orbit parameters but in the compressed form storing compressed values of satellite orbit parameters (hereinafter referred to as “compressed long-term prediction ephemeris”). Thus, the server system 3 is a type of data compressing device. The original values herein refer to original values different from compressed values described later. The server system 3 transmits the compressed long-term prediction ephemeris thus produced to the cellular phone 4 having transmitted a request signal.

The cellular phone 4 is an electronic device through which a user receives and transmits telephone communication, mails and the like, and includes a positioning device providing position measuring function (positioning function) as well as original function such as reception and transmission of telephone communication and mails as cellular phone.

The cellular phone 4 transmits a request signal requesting compressed long-term prediction ephemeris to the server system 3 in response to operation by the user, and receives compressed long-term prediction ephemeris from the server system 3. Then, the cellular phone 4 expands the received compressed long-term prediction ephemeris to produce long-term predicted ephemeris in the complete form storing not the compressed values but the original values (hereinafter referred to as “complete long-term prediction ephemeris”), and captures the GPS satellites SV and measures the positions of the GPS satellites SV using the complete long-term prediction ephemeris.

### 2. PRINCIPLE

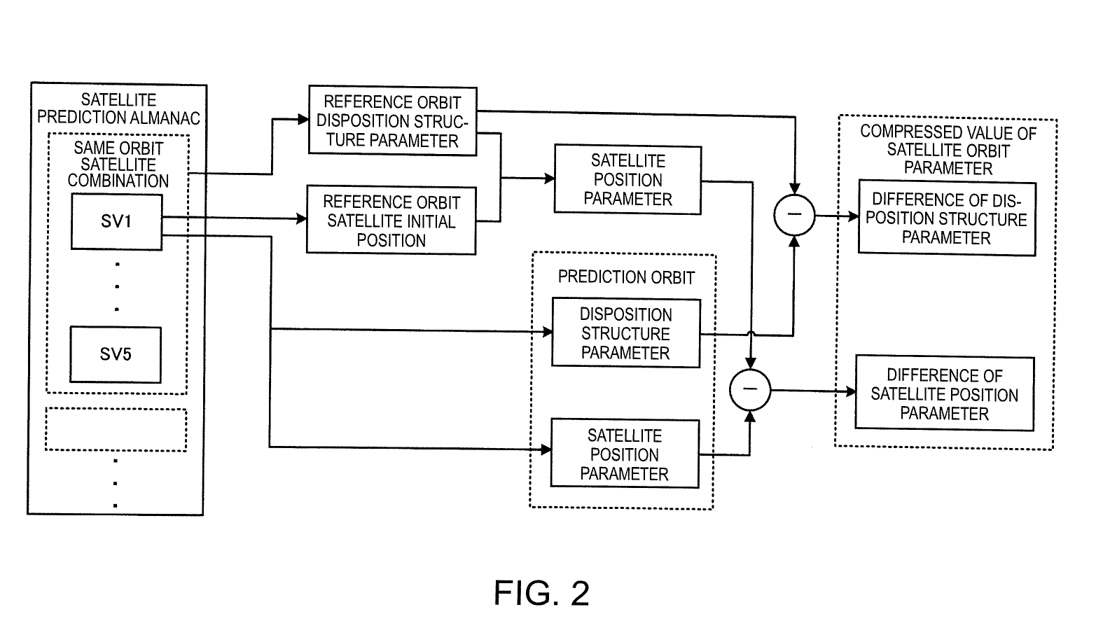

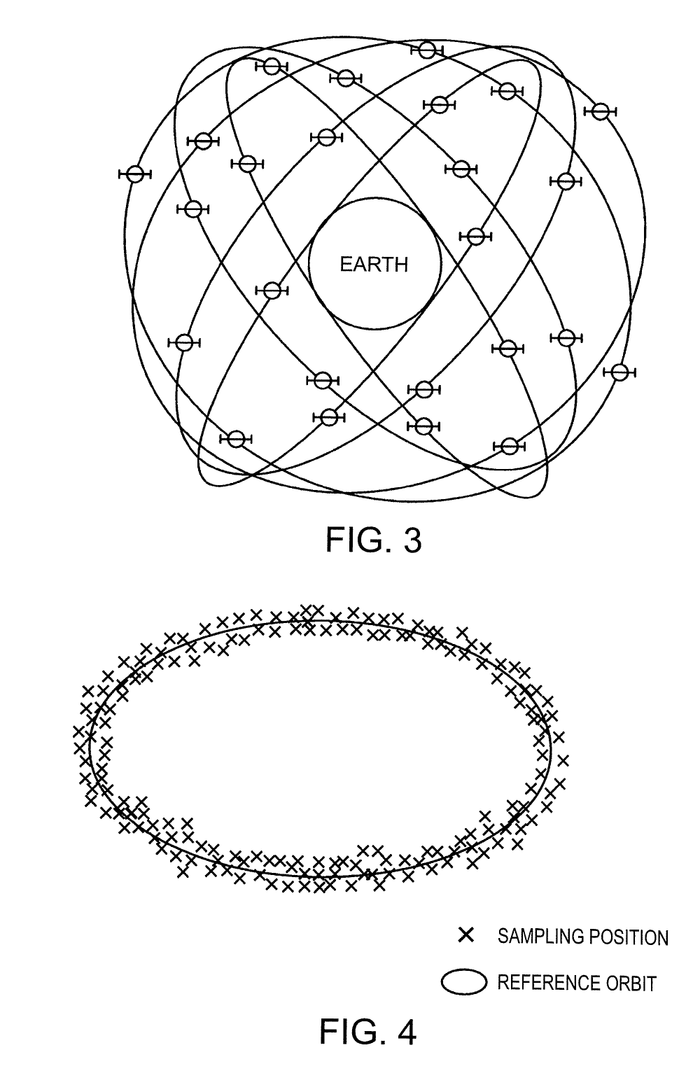

FIGS. 2 through 5 illustrate the principle for producing the compressed long-term prediction ephemeris according to this embodiment. As illustrated in FIG. 3, four or more GPS satellites SV are disposed on each of six orbit planes around the earth and operated such that four or more satellites can be constantly observed from any locations on the earth based on the geometrical disposition in principle.

The present inventors have developed a method for reducing the data amount of the long-term prediction ephemeris based on the characteristics of the satellites disposed on the same orbit plane around the earth (hereinafter referred to as “same orbit satellites”) that the same orbit satellites move along approximately the same orbits though not absolutely the same orbit without any difference due to disturbance. FIG. 2 shows the flow of compression of the long-term prediction ephemeris according to this embodiment.

Initially, predicted positions of the same orbit satellites are extracted as sampling positions from discrete predicted positions of all the GPS satellites SV stored in the satellite prediction almanac received from the external system 2. FIG. 4 illustrates a concept of the predicted positions of the same orbit satellites as sampling positions. The satellite prediction almanac stores predicted positions in time series for a period of one week, for example. The sampling positions to be extracted are all the predicted positions of the same orbit satellites at all times stored in time series.

Then, a “reference orbit (standard orbit)” as the average orbit of the same orbit satellites is calculated based on the extracted sampling positions. That is, the same orbit along which the same orbit satellites move is obtained as the reference orbit. The reference orbit is calculated using a minimum square method such that the sum of squares of the distance between the sampling positions and the reference orbit becomes the minimum, for example. Since the number of the satellite orbits is six, six combinations (six orbits) of the same orbit satellites (hereinafter referred to as “same orbit satellite combinations” exist. Thus, six reference orbits are calculated in total.

The reference orbit has an elliptic shape, and defined based on Kepler's elliptic orbit model. The technology for defining the satellite orbit using the Kepler's elliptic orbit model is a known technology, and thus the detailed explanation is not given herein. The Kepler's elliptic orbit model has plural parameters. Thus, calculation of these parameters corresponds to defining the reference orbit.

The parameters of the reference orbit to be calculated include two types of parameters: parameters indicating the disposition structure of the orbit calculated based on the Kepler's elliptic orbit model such as direction, shape, and size of the elliptic orbit (hereinafter referred to as “reference orbit disposition structure parameters”); and parameters for specifying the satellite positions at arbitrary times as variables (hereinafter referred to as “satellite position parameters”). Initially, the reference orbit disposition structure parameters are calculated. The reference orbit disposition structure parameters include “orbit semimajor axis” indicating the size of the orbit, “eccentricity” indicating the degree of crush of the orbit, and “orbit inclination angle” indicating a relative inclination angle of the orbit with respect to the earth, for example.

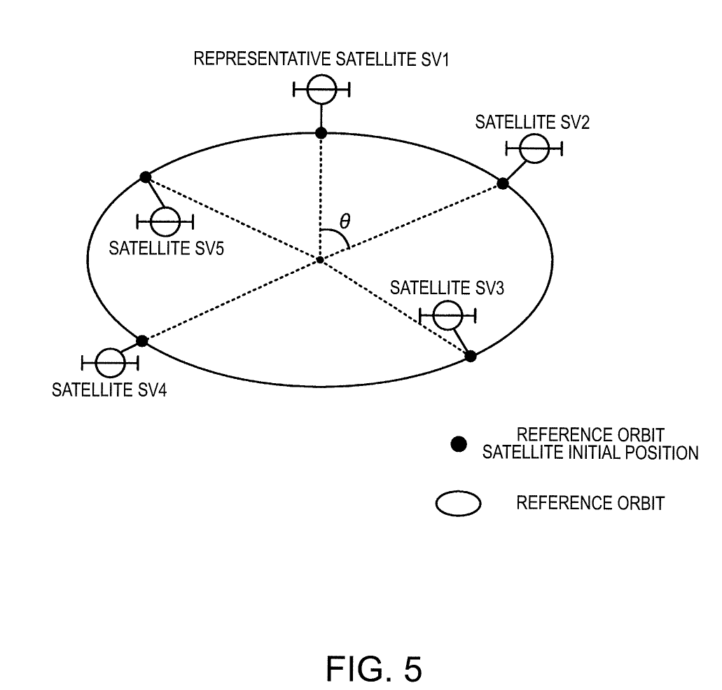

Then, the initial positions of the same orbit satellites on the reference orbit (hereinafter referred to as “reference orbit satellite initial positions”) are determined. FIG. 5 shows the method for determining the reference orbit satellite initial positions. In FIG. 5, the satellites SV1 through SV5 are the same orbit satellites, and the positions of these satellites correspond to the oldest positions (initial positions) in the satellite prediction almanac. After the reference orbit is calculated, vertical lines from the respective initial positions of the same orbit satellites in the satellite prediction almanac to the reference orbit. The cross points of the vertical lines and the reference orbit correspond to the reference orbit satellite initial positions. The positions of black circles in FIG. 5 indicate the reference orbit satellite initial positions.

The reference orbit satellite initial positions can be represented by position coordinates (coordinate values) of the satellites on the reference orbit. According to this embodiment, however, the reference orbit satellite initial positions are indicated by angles formed by the reference orbit satellite initial position of the representative satellite as the reference (0°) and the reference orbit satellite initial positions of the other satellites while setting the center of the reference orbit as the center of angle calculation. One representative satellite is selected for each of the same orbit satellite combinations, such as the satellite having the smallest number in the identification numbers (satellite numbers) given to the respective satellites of the corresponding same orbit satellite combination beforehand.

FIG. 5 shows the case in which the satellite SV1 is selected as the representative satellite from the same orbit satellites SV1 through SV5. In this case, the reference orbit satellite initial positions of the other same orbit satellites SV2 through SV5 are indicated by angles “θ” in the range from 0° to 360° with the positive direction set at the clockwise direction in the figure, for example, and with the reference (0°) set at the reference orbit satellite initial position of the representative satellite SV1. In the practical case, the angles may be defined while assuming a predetermined coordinate system which sets the reference at the center of the reference orbit. For example, such a method which assumes right-handed orthogonal three-dimensional coordinate system whose Z axis extends from the center of the reference orbit (center of the earth) toward the center of the sun can be used.

After the reference orbit disposition structure parameters and the reference orbit satellite initial positions are obtained, parameters for specifying the respective reference orbit positions of the same orbit satellites at a certain time (satellite position parameters described above) are calculated. The satellite position parameters include known parameters such as “average anomalistic elongation”. The reference orbit disposition structure parameters are common to all of the same orbit satellites in each of the same orbit satellite combinations, but the satellite position parameters are peculiar to each of the same orbit satellites.

It is possible to estimate (predict) a future satellite orbit of each GPS satellite from each predicted position of the GPS satellites SV stored in the satellite prediction almanac based on the Kepler's elliptic orbit model. The future satellite orbit for each GPS satellite SV is referred to as “prediction orbit”.

The respective values of the disposition structure parameters and the respective values of the satellite position parameters calculated based on the reference orbit, and the respective values of the disposition structure parameters and the respective values of the satellite position parameters calculated based on the prediction orbit are thus calculated by these processes for all of the GPS satellites SV. Then, the differences between the corresponding parameters calculated from the reference orbit and from the prediction orbit are obtained as compression values of the satellite orbit parameters. Compressed long-term prediction ephemeris is data corresponding to the calculated differences (compressed values) instead of the original values of the satellite orbit parameters.

### 3. SERVER SYSTEM

### 3-1. Function Structure

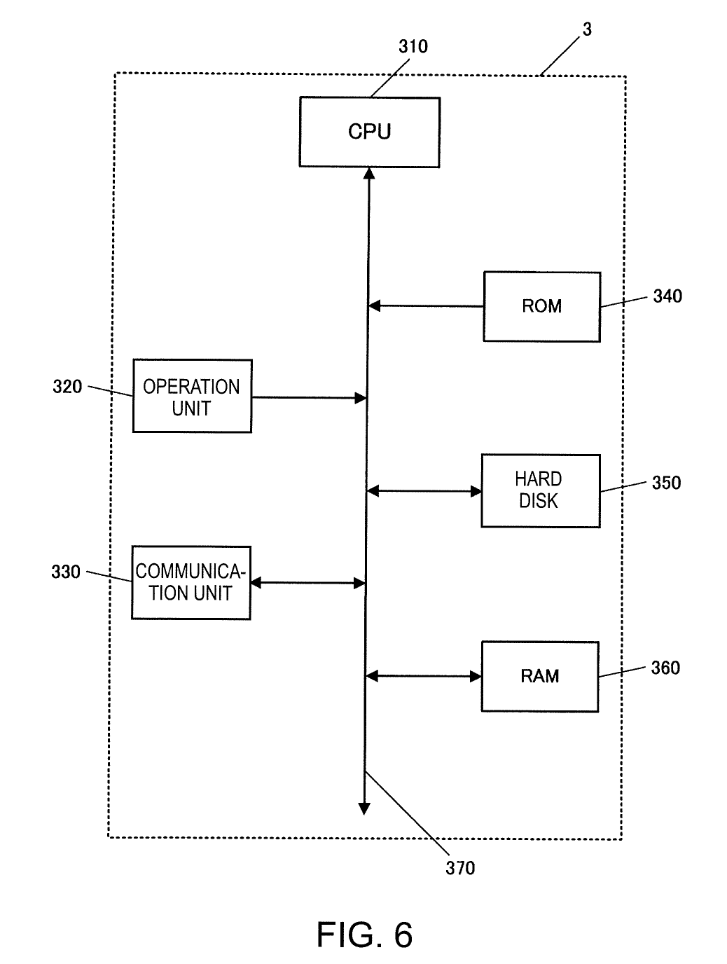

FIG. 6 is a block diagram showing the function structure of the server system 3. The server system 3 is a computer system which includes a CPU (central processing unit) 310, an operation unit 320, a communication unit 330, a ROM (read only memory) 340, a hard disk 350, and a RAM (random access memory) 360. These units of the server system 3 are connected with each other via a bus 370.

The CPU 310 is a processor which collectively controls the respective units of the server system 3 under a system program or the like stored in the ROM 340. According to this embodiment, the CPU 310 performs process for providing the compressed long-term prediction ephemeris to the cellular phone 4 according to a compressed long-term predicted ephemeris providing program 341 stored in the ROM 340.

The operation unit 320 is an input device which receives an operation command issued by a manager of the server system 3 and outputs a signal corresponding to the operation to the CPU 310. This function is provided through keyboard, button, mouse or the like.

The communication unit 330 is a communication device which exchanges various data used in the system with the external system 2 and the cellular phone 4 via communication network such as the Internet.

The ROM 340 is a non-volatile read-only memory unit which stores various programs and data such as the system program for controlling the server system 3 by the CPU 310, a program for providing the compressed long-term prediction ephemeris to the cellular phone 4, and a program for producing the compressed long-term prediction ephemeris.

The hard disk 350 is a memory unit which reads and writes data using a magnetic head or the like, and stores programs and data for providing various types of functions of the server system 3 similarly to the ROM 340.

The RAM 360 is a volatile readable and writable memory unit, and has a work area for temporarily storing the system program performed by the CPU 310, the compressed long-term prediction ephemeris providing program, various processing programs, data used during respective processes, process results, and others.

### 3-2. Data Structure

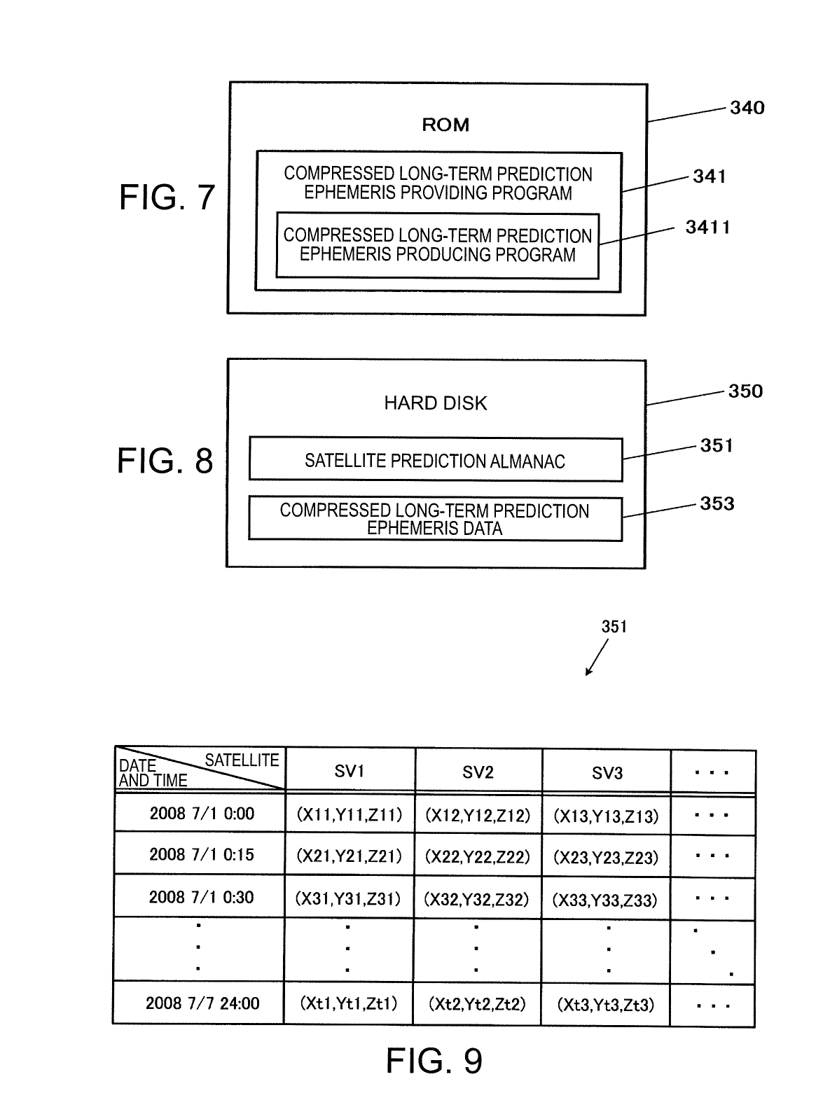

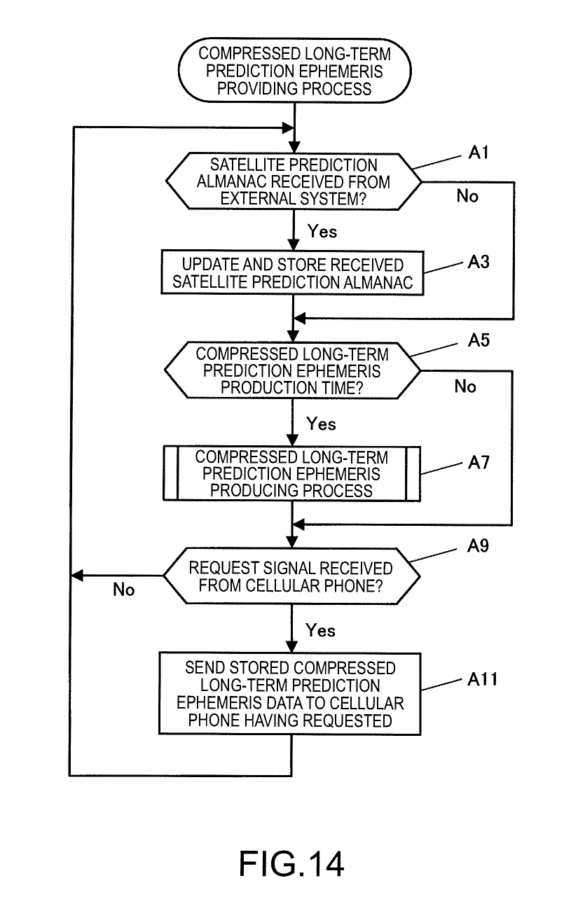

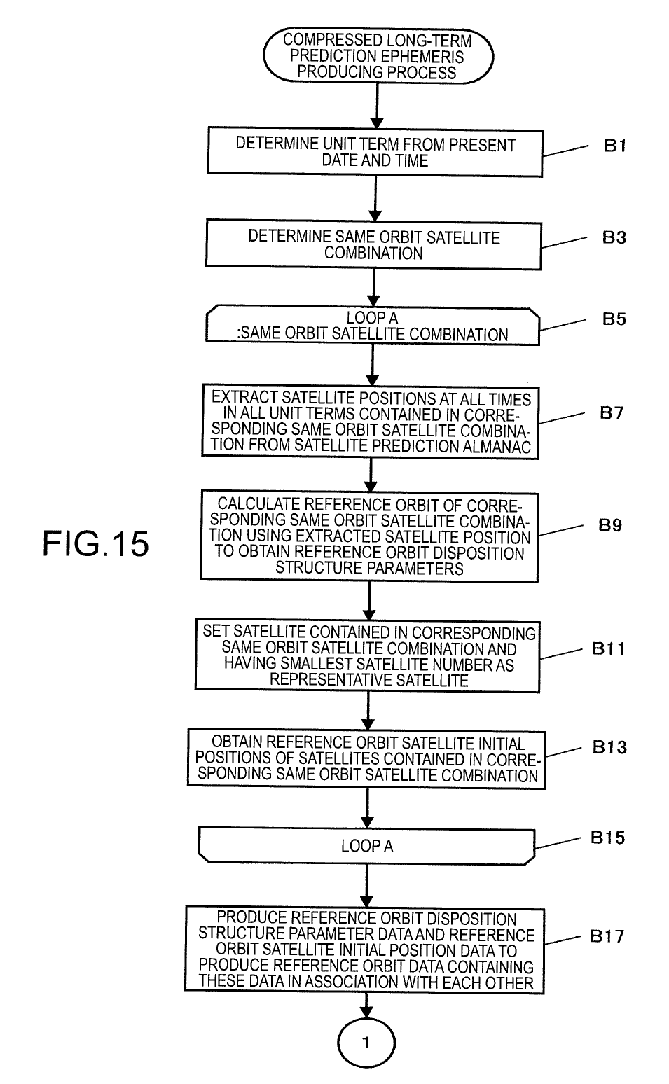

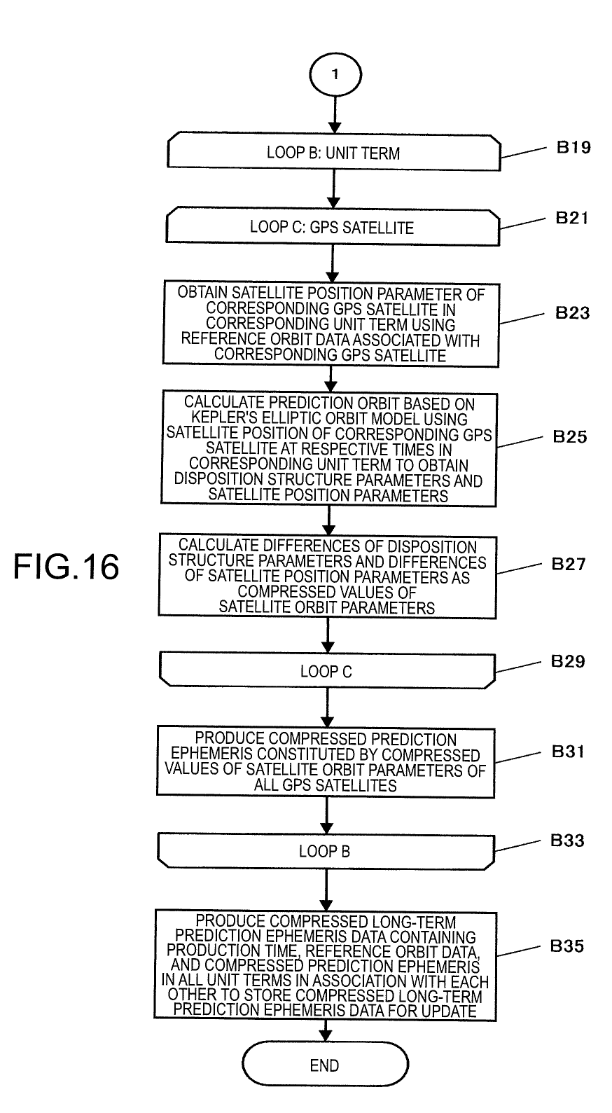

FIG. 7 shows an example of data stored in the ROM 340. The ROM 340 stores the compressed long-term prediction ephemeris providing program 341 read and performed as compressed long-term prediction ephemeris providing process (see FIG. 14) by the CPU 310. The compressed long-term prediction ephemeris providing program 341 includes a compressed long-term prediction ephemeris producing program 3411 performed as compressed long-term prediction ephemeris producing process (see FIGS. 15 and 16) as sub routine.

According to the compressed long-term prediction ephemeris providing process, the CPU 310 periodically performs process for producing compressed long-term prediction ephemeris. When receiving a request signal for compressed long-term prediction ephemeris from the cellular phone 4, the CPU 310 sends compressed long-term prediction ephemeris produced to the cellular phone 4 having requested the prediction ephemeris. The compressed long-term prediction ephemeris providing process will be described in detail later with reference to a flowchart.

The compressed long-term prediction ephemeris producing process is a process for producing compressed long-term prediction ephemeris based on the principle discussed above. In this embodiment, the CPU 310 produces compressed long-term prediction ephemeris once for every four hours. More specifically, the CPU 310 produces 28 pieces of prediction ephemeris each of which corresponds to a unit term of six hours in a prediction period of one week from the production date and time for producing the compressed long-term prediction ephemeris as a reference. Then, the CPU 310 produces the compressed long-term prediction ephemeris constituted by the reference orbit data and the 28 pieces of the compressed predicted ephemeris for the respective unit terms. The compressed long-term predicted ephemeris producing process will be also described in detail later with reference to a flowchart.

FIG. 8 shows an example of data stored in the hard disk 350. The hard disk 350 stores satellite prediction almanac 351 and compressed long-term prediction ephemeris data 353.

FIG. 9 shows an example of data structure of the satellite prediction almanac 351. The satellite prediction almanac 351 is discrete data showing the respective positions of the GPS satellites SV stored for every 15 minutes in one week. The satellite positions are represented by three-dimensional values in the earth reference coordinate system, for example. According to this system, the satellite position of the GPS satellite “SV2” at “0:30, Jul. 1, 2008” is represented by “(X32, Y32, Z32)”. The CPU 310 receives the satellite prediction almanac 351 periodically (such as once for every four hours) from the external system 2 to store the satellite prediction almanac 351 in the hard disk 350 for update.

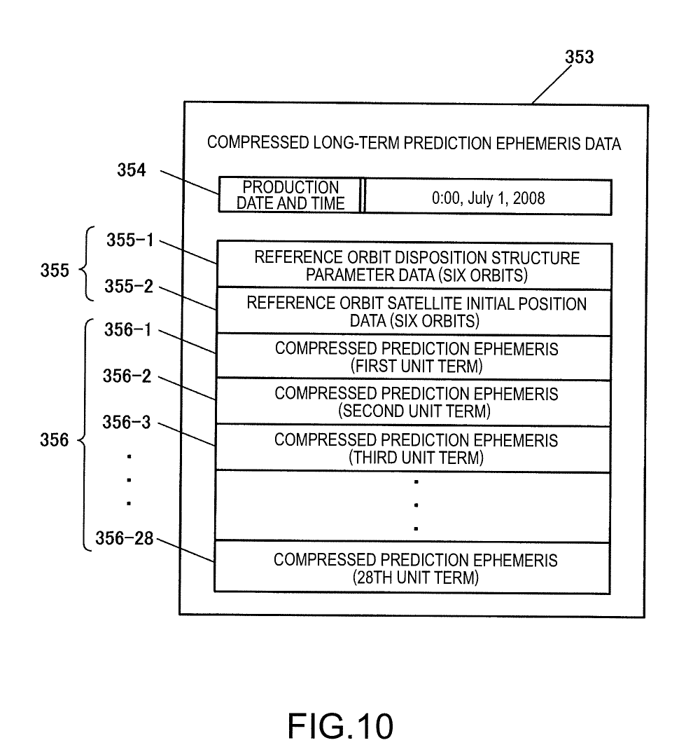

FIG. 10 shows an example of data structure of the compressed long-term prediction ephemeris data 353. The compressed long-term prediction ephemeris data 353 contains a production date and time 354 for producing the compressed long-term prediction ephemeris, reference orbit data 355 constituted by reference orbit disposition structure parameter data 355-1 and reference orbit satellite initial position data 355-2, and compressed prediction ephemeris 356 (356-1 through 356-28) for the first through 28th unit terms in association with each other.

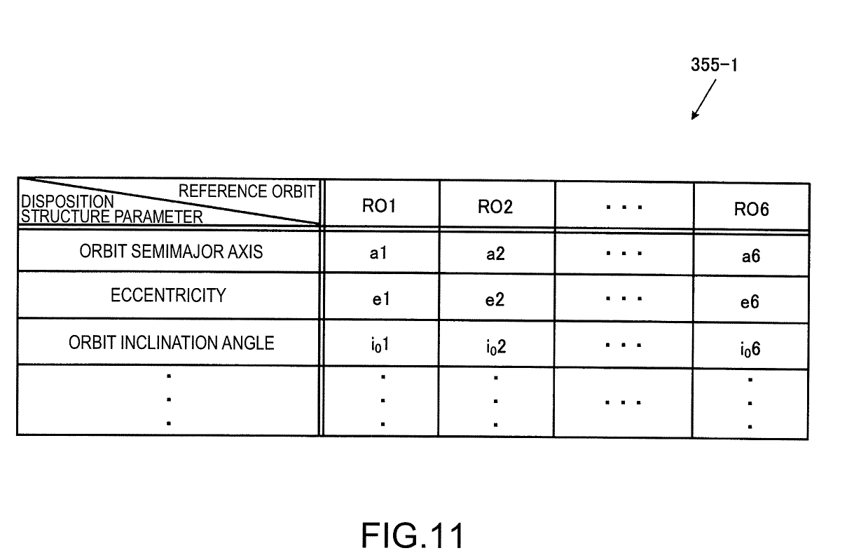

FIG. 11 shows an example of data structure of the reference orbit disposition structure parameter data 355-1. The reference orbit disposition structure parameter data 355-1 stores disposition structure parameters such as orbit semimajor axis, eccentricity, and orbit inclination angle for each of six reference orbits RO1 through RO6. For example, the eccentricity of the reference orbit “OR6” is “e6”.

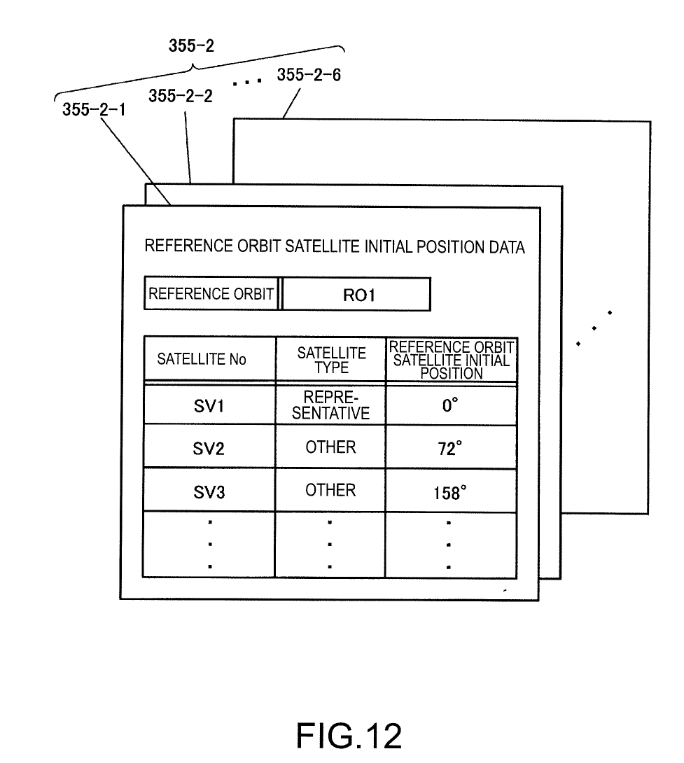

FIG. 12 shows an example of data structure of the reference orbit satellite initial position data 355-2. The reference orbit satellite initial position data 355-2 (355-2-1, 355-2-2, up to 355-2-6) stores satellite numbers, satellite types, and reference orbit satellite initial positions of the same orbit satellites in association with each other for each of the six reference orbits RO1 through RO6.

For the satellite types, “representative” is stored when the corresponding same orbit satellite is the representative satellite, and “other” is stored when not the representative satellite. For the reference orbit satellite initial positions, the respective angles of the same orbit satellites (0° through 360°) with the reference (0°) set at the reference orbit satellite initial position of the representative satellite as discussed in “Principle”. The data amount can be reduced by storing not the position coordinates but the angles as the reference orbit satellite initial positions. For example, the same orbit satellite “SV2” is not the representative satellite in the same orbit satellite combination of the reference orbit RO1, and has the reference orbit satellite initial position of “72°”.

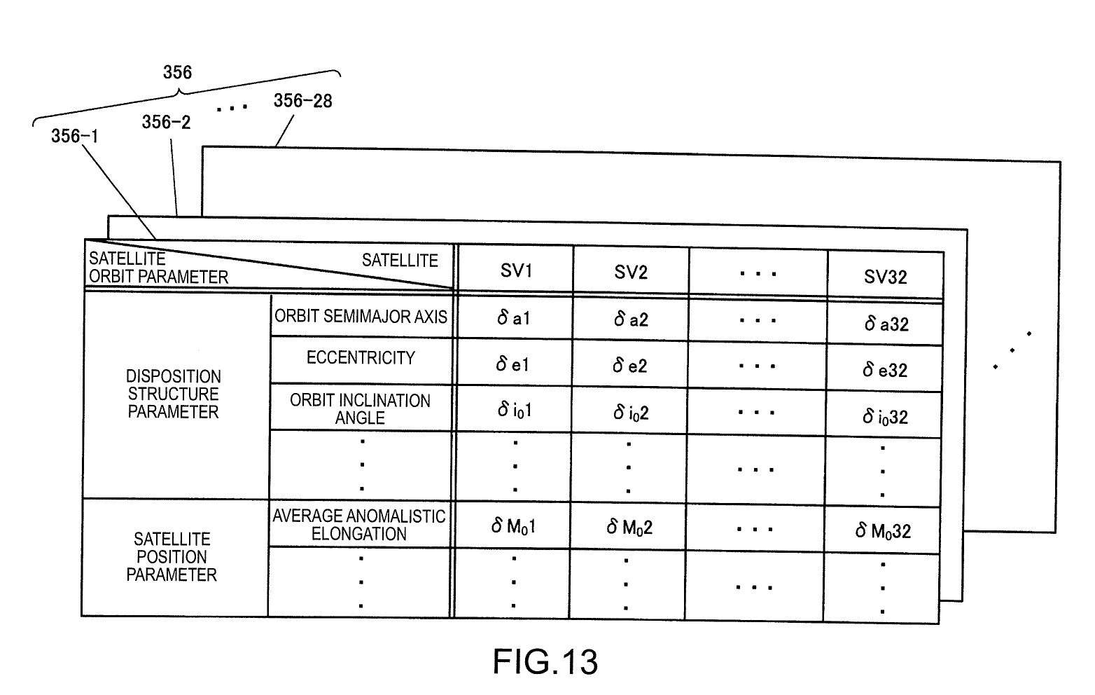

FIG. 13 shows an example of data structure of the compressed prediction ephemeris 356. The compressed prediction ephemeris 356 (356-1, 356-2, up to 356-28) stores the differences of the disposition structure parameters such as orbit semimajor axis, eccentricity, and orbit inclination angle, and the differences of the satellite position parameters such as average anomalistic elongation as the compressed values of the satellite orbit parameters for each of the satellites SV1 through SV 32. For example, the difference of the orbit semimajor axis in the disposition structure parameters for the GPS satellite “SV1” is “δa1”. Also, the difference of the average anomalistic elongation in the satellite position parameters is “δMₒ1”.

### 3-3. Flow of Process

FIG. 14 is a flowchart showing the flow of the compressed long-term prediction ephemeris providing process performed by the server system 3 under the compressed long-term prediction ephemeris providing program 341 stored in the ROM 340 read and executed by the CPU 310.

Initially, the CPU 310 judges whether the satellite prediction almanac 351 has been received from the external system 2 (step A1). When it is judged that the satellite prediction almanac 351 has not been received (step A1; NO), the flow goes to step A5. When it is judged that the satellite prediction almanac 351 has been received (step A1; YES), the received satellite prediction almanac 351 is stored in the hard disk 350 for update (step A3).

Then, the CPU 310 judges whether it is the time for producing the compressed long-term prediction ephemeris (step A5). In this embodiment, the compressed long-term prediction ephemeris is produced once for every four hours. When it is judged that it is not the production time (step A5; NO), the CPU 310 shifts the flow to step A9.

When it is judged that it is the time for producing the compressed long-term prediction ephemeris (step A5; YES), the CPU 310 performs the compressed long-term prediction ephemeris producing process by reading and executing the compressed long-term prediction ephemeris producing program 3411 stored in the ROM 340 (step A7).

FIGS. 15 and 16 are flowcharts showing the flow of the compressed long-term prediction ephemeris producing process.

Initially, the CPU 310 determines the respective unit terms based on the present date and time (step B1). More specifically, the CPU 310 determines each period of six hours in one week from the present date and time (production date and time) as the unit term. Then, the CPU 310 determines the same orbit satellite combinations (step B3).

The CPU 310 performs the process of loop A for each of the same orbit satellite combinations determined in step B3 (step B5 through B15). In the process of loop A, the CPU 310 extracts the satellite positions at all times in all unit terms of the satellites contained in the corresponding same orbit satellite combination from the satellite almanac 351 stored in the hard disk 350 (at intervals of 15 minutes stored in the satellite prediction almanac 351 as times included in the corresponding unit terms) (step B7).

The CPU 310 uses the satellite positions extracted in step B7 to calculate the reference orbit of the corresponding same orbit satellite combination using the minimum square method as discussed with reference to FIG. 4, for example, to obtain the respective reference orbit disposition structure parameters (step B9). Then, the CPU 310 determines the satellite having the smallest satellite number contained in the corresponding same orbit satellite combination as the representative satellite (step B11).

The CPU 310 calculates the reference orbit satellite initial positions of the respective satellites contained in the corresponding same orbit satellite combination as discussed with reference to FIG. 5 (step B13). Then, the CPU 310 shifts the process to the next same orbit satellite combination.

After the processes from step B7 to step B13 are completed for all of the same orbit satellite combinations, the CPU 310 ends the process of loop A (step B15). After the process of loop A is finished, the CPU 310 produces the reference orbit disposition structure parameter data 355-1 and the reference orbit satellite initial position data 355-2, and produces the reference orbit data 355 including these data 355-1 and 355-2 in association with each other (step B17).

The CPU 310 performs the process of loop B for each of the unit terms determined in step B1 (steps B19 through B33). In the process of loop B, the CPU 310 executes the process of loop C for each of the GPS satellites SV (steps B21 through B29).

In the process of loop C, the CPU 310 obtains the respective satellite position parameters in the corresponding unit term for the corresponding GPS satellite SV using the reference orbit data 355 associated with the corresponding GPS satellite SV (step B23). The CPU 310 also calculates a prediction orbit based on the Kepler's elliptic orbit model using the satellite positions at the respective times in the corresponding unit term for the corresponding GPS satellite SV while referring to the satellite prediction almanac to obtain the respective disposition structure parameters and satellite position parameters (step B25).

The CPU 310 calculates the differences between the parameters obtained in the steps B9 and B23 and the parameters obtained in step B25 associated with each other, and determines the differences as the compressed values of the satellite orbit parameters (step B27). Then, the CPU 310 shifts the process to the next GPS satellite SV.

After the processes from step B23 through B27 are completed for all of the GPS satellites SV, the CPU 310 ends the process of loop C. After the process of the loop C is finished, the CPU 310 produces the compressed prediction ephemeris 356 constituted by the compressed values of the satellite orbit parameters for all of the GPS satellites SV (step B31). Then, the CPU 310 shifts the process to the next unit term.

After the processes from step B21 through B31 are completed for all of the unit terms, the CPU 310 ends the process of loop B (step B33). After the process of the loop B is finished, the CPU 310 produces the compressed long-term prediction ephemeris data 353 including the production date and time 354, the reference orbit data 355 produced in step B17, the compressed prediction ephemeris 356 produced in step B31 for all of the unit terms in association with each other, and stores the compressed long-term prediction ephemeris data 353 in the hard disk 350 for update (step B35). Then, the CPU 310 ends the compressed long-term prediction ephemeris producing process.

Returning to the compressed long-term prediction ephemeris providing process shown in FIG. 14, the CPU 310 judges whether a request signal for compressed long-term prediction ephemeris has been received from the cellular phone 4 after completion of the compressed long-term prediction ephemeris producing process (step A9). When it is judged that the request signal has not been received (step A9; NO), the flow returns to step A1.

When it is judged that the request signal has been received (step A9; YES), the CPU 310 transmits the compressed long-term prediction ephemeris data 353 stored in the hard disk 350 to the cellular phone 4 having requested the data 353 (step A11). Then, the CPU 310 returns to step A1.

### 4. CELLULAR PHONE

### 4-1. Function Structure

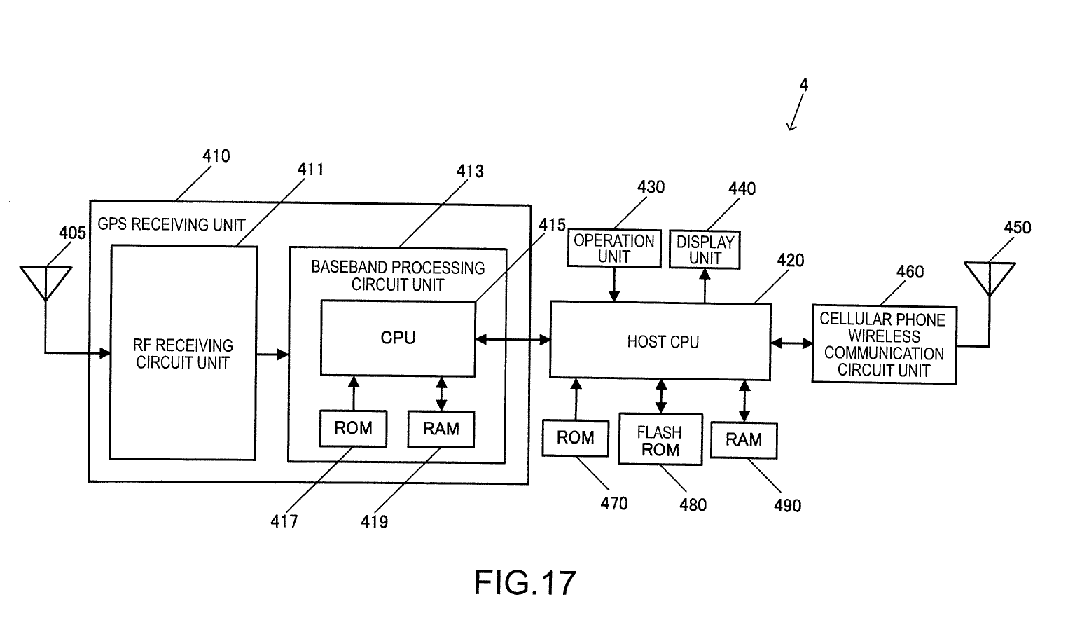

FIG. 17 is a block diagram showing the function structure of the cellular phone 4. The cellular phone 4 includes a GPS antenna 405, a GPS receiving unit 410, a host CPU 420, an operation unit 430, a display unit 440, a cellular phone antenna 450, a cellular phone wireless communication circuit unit 460, a ROM 470, a flash ROM 480, and a RAM 490.

The GPS antenna 405 is an antenna which receives RF (radio frequency) signals containing GPS satellite signals transmitted from the GPS satellites SV, and outputs the received signals to the GPS receiving unit 410. The GPS satellite signals are communication signals having 1.57542 [GHz] and modulated by direct spectrum diffusion system using PRN (pseudo random noise) codes as a type of diffusion codes different for each satellite. The PRN codes are pseudo random noise codes having repetitive cycle of 1 ms and having code length of 1,023 chips as 1PN frame.

The GPS receiving unit 410 is a positioning circuit for measuring positions based on the signals outputted from the GPS antenna 405 as a function block corresponding to a so-called GPS receiver. The GPS receiving unit 410 includes an RF (radio frequency) receiving circuit unit 411, and a baseband processing circuit unit 413. The RF receiving circuit unit 411 and the baseband processing circuit unit 413 can be manufactured as separate LSI (large scale integration), or as 1 chip unit.

The RF receiving circuit unit 411 is a circuit block for processing RF signals, and produces oscillation signals to be multiplied by RF signals by dividing or multiplying predetermined local oscillation signals. The RF signals outputted from the GPS antenna 405 are multiplied by the produced oscillation signals to be down-converted into intermediate frequency signals (herein after referred to as “IF (intermediate frequency) signals”). Then, the IF signals are amplified or processed in other ways, and converted into digital signals by an A/D (analog/digital) converter to be outputted to the baseband processing circuit unit 413.

The baseband processing circuit unit 413 is a circuit unit for capturing and extracting GPS satellite signals by applying correlation process or the like to the IF signals outputted from the RF receiving circuit unit 411. The baseband processing circuit unit 413 has a CPU 415 as processor, and a ROM 417 and a RAM 419 as memories. The CPU 415 captures and extracts the GPS satellite signals using complete long-term prediction ephemeris obtained by expanding compressed long-term prediction ephemeris via the host CPU 420.

The host CPU 420 is a processor which collectively controls the respective units of the cellular phone 4 according to various programs such as positioning calculation program and system program stored in the ROM 470. The host CPU 420 obtains navigation message and time information by decoding data in the GPS satellite signals captured and extracted by the baseband processing circuit unit 413 to perform positioning calculation. Then, the host CPU 420 displays a navigation screen where measured positions resulting from positioning calculation are plotted on the display unit 440.

The operation unit 430 is an input device which includes a tough panel, button switches and the like, and outputs signals corresponding to pressed icons and buttons to the host CPU 420. Various types of commands such as telephone communication request, mail transmission and reception request, and GPS startup request are inputted through operation of the operation unit 430.

The display unit 440 is a display device constituted by LCD (liquid crystal display) or the like to provide various displays corresponding to display signals received from the host CPU 420. The display unit 440 displays navigation screen, time information and the like.

The cellular phone antenna 450 is an antenna which transmits and receives cellular phone wireless signals to and from a wireless base station provided by a communication service provider of the cellular phone 4.

The cellular phone wireless communication circuit unit 460 is a cellular phone communication circuit unit including an RF converting circuit, a baseband processing circuit and the like. The cellular phone wireless communication circuit unit 460 provides telephone communication and mail transmission and reception by modulating and demodulating cellular phone wireless signals.

The ROM 470 is a non-volatile read-only memory unit which stores various programs and data such as a system program for controlling the cellular phone 4 by the host CPU 420, a positioning calculation program for performing positioning calculation, and a navigation program for providing navigation function.

The flash ROM 480 is a readable and writable non-volatile memory unit which stores various programs and data for controlling the cellular phone 4 by the host CPU 420 similarly to the ROM 470. The data stored in the flash ROM 480 is not lost even after the power source of the cellular phone 4 is turned off.

The RAM 490 is a readable and writable volatile memory unit which has a work area for temporarily storing the system program performed by the host CPU 420, the positioning calculation program, various processing programs, data used during various processes, process results and the like.

### 4-2. Data Structure

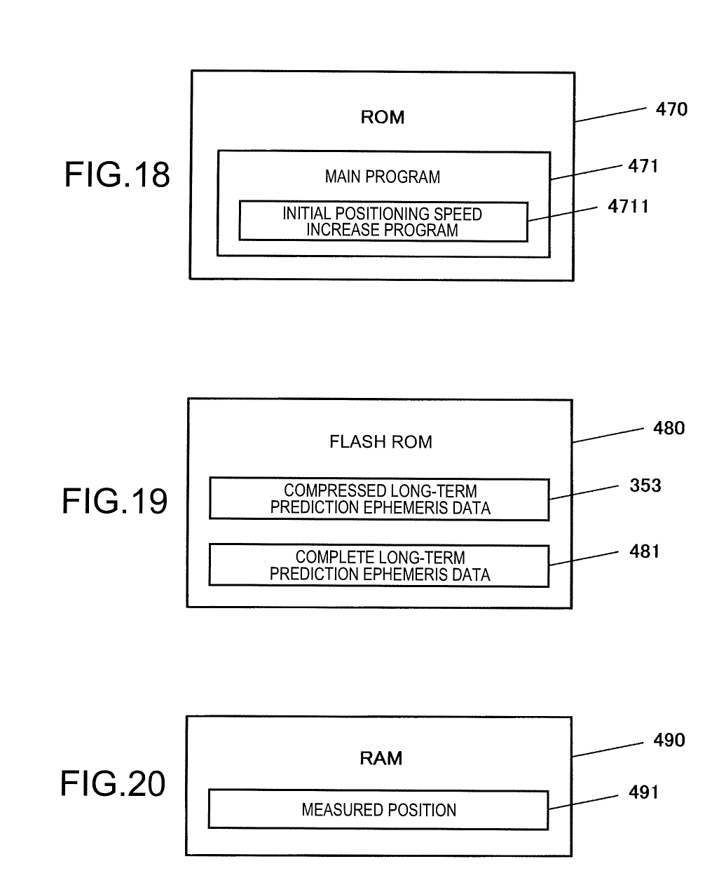

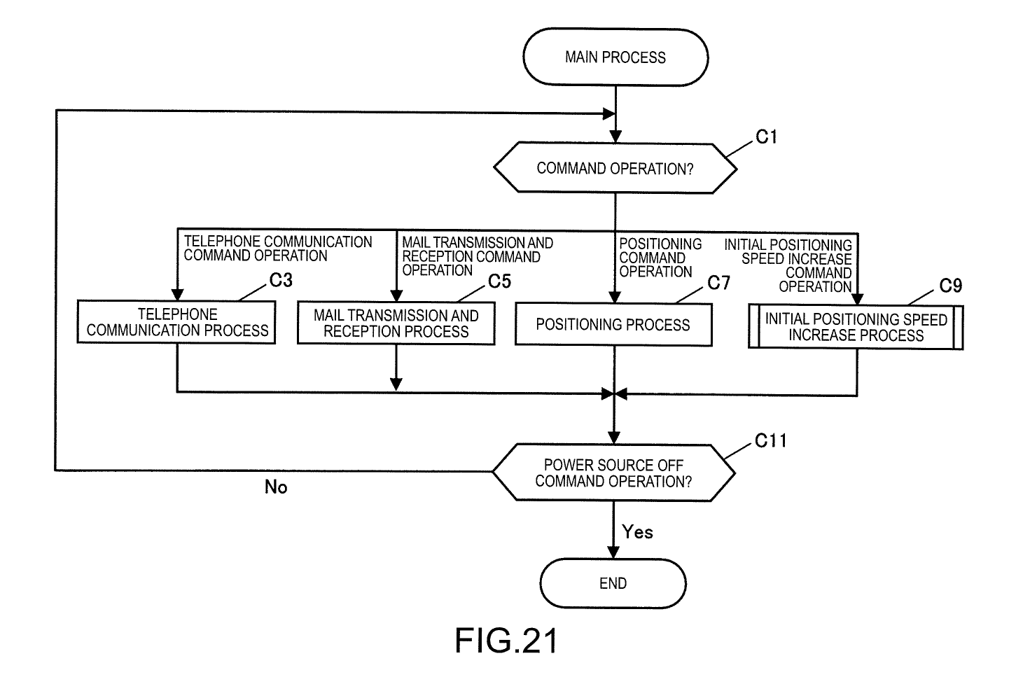

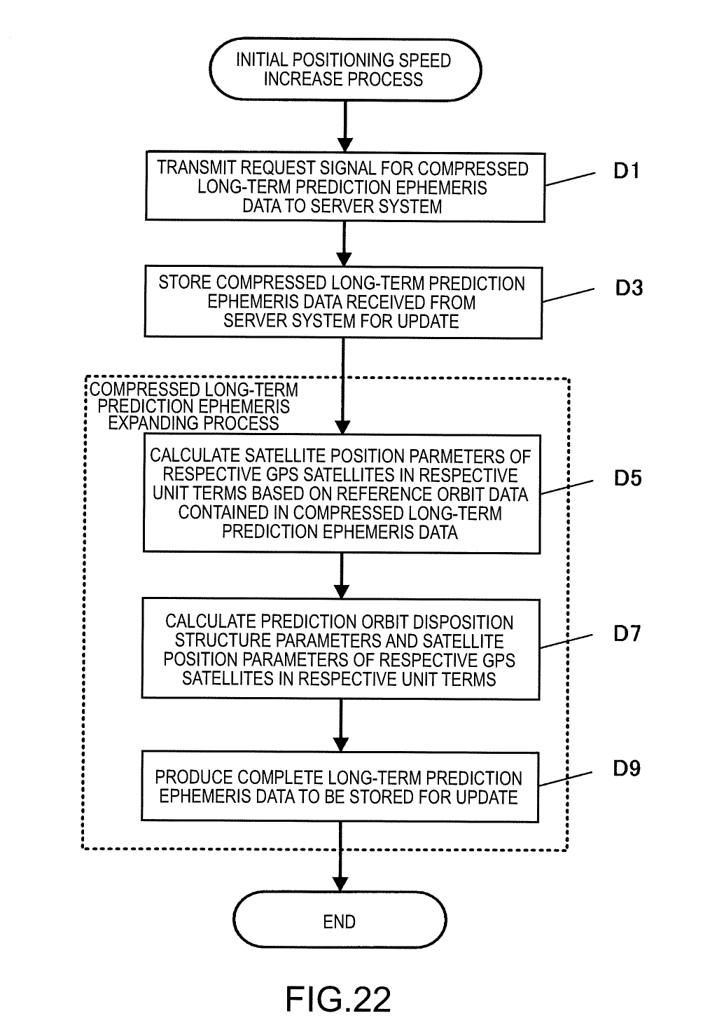

FIG. 18 shows an example of data stored in the ROM 470. The ROM 470 stores a main program 471 to be read and performed by the host CPU 420 as main process (see FIG. 21). The main program 471 contains an initial positioning speed increase program 4711 performed as initial positioning speed increase process (see FIG. 22) in the form of sub routine.

The main process includes process of the host CPU 420 for providing telephone communication and mail transmission and reception as the original function of the cellular phone 4, process for measuring the position of the cellular phone 4 (positioning process), process for increasing the speed of initial positioning after turning on the power source of the cellular phone 4, and other processes. The main process will be described in detail later with reference to a flowchart.

In the initial positioning speed increase process, the host CPU 420 sends a request signal for compressed long-term prediction ephemeris data to the server system 3, and expands the compressed long-term prediction ephemeris data received from the server system 3 to restore the compressed data to complete long-term prediction ephemeris data. By this process, the GPS satellites SV can be captured for initial positioning by using the restored complete long-term prediction ephemeris data at higher speed of initial positioning. The initial positioning speed increase process will be described in detail later with reference to a flowchart as well.

FIG. 19 shows an example of data stored in the flash ROM 480. The flash ROM 480 stores the compressed long-term prediction ephemeris data 353 received from the server system 3, and complete long-term prediction ephemeris data 481 obtained by expanding the compressed long-term prediction ephemeris data 353. The complete long-term prediction ephemeris data 481 is data storing the original values of the satellite orbit parameters of all the GPS satellites SV in all the unit terms.

FIG. 20 shows an example of data stored in the RAM 490. The RAM 490 stores measured positions 491 obtained by the positioning process. The measured positions 491 are updated by the host CPU 420 during the main process.

### 4-3. Flow of Process

FIG. 21 is a flowchart showing the flow of the main process performed by the cellular phone 4 under the main program 471 in the ROM 470 read and performed by the host CPU 420.

The main process starts when the host CPU 420 detects that the user has executed power ON operation through the operation unit 430. Though not particularly explained, reception of RF signals by the GPS antenna 405 and down-conversion of RF signals into IF signals by the RF receiving circuit unit 411 are carried out while the main process is performed. In this condition, IF signals are outputted to the baseband processing circuit unit 413 as necessary.

Initially, the host CPU 420 judges command operation given through the operation unit 430 (step C1). When it is judged that the command operation is telephone communication command operation (step C1; telephone communication command operation), telephone communication process is performed (step C3). More specifically, the host CPU 420 commands the cellular phone wireless communication circuit unit 460 to provide base station communication with the wireless base station such that telephone communication can be provided between the cellular phone 4 and other device.

When it is judged that the command operation is mail transmission and reception command operation in step C1 (step C1; mail transmission and reception command operation), the host CPU 420 performs mail transmission and reception process (step C5). More specifically, the host CPU 420 commands the cellular phone wireless communication circuit unit 460 to provide base station communication with the wireless base station such that mail transmission and reception can be provided between the cellular phone 4 and other device.

When it is judged that the command operation is positioning command operation in step C1 (step C1; positioning command operation), the host CPU 420 performs positioning process (step C7). More specifically, the host CPU 420 commands the CPU 415 of the baseband processing circuit unit 413 to capture and extract GPS satellite signals using the complete long-term prediction ephemeris data 481 stored in the flash ROM 480.

Then, the host CPU 420 reads and performs the positioning calculation program stored in the ROM 470, and measures positions based on predetermined positioning calculation using the GPS satellite signals captured and extracted by the CPU 415. The positioning calculation may be performed by known calculation method such as minimum square method and positioning calculation using Karman filter. Then, the host CPU 420 stores the measured positions 491 obtained by the positioning calculation in the RAM 490.

When it is judged that the command operation is initial positioning speed increase command operation in step C1 (step C1; initial positioning speed increase command operation), the host CPU 420 performs initial positioning speed increase process (step C9).

FIG. 22 is a flowchart showing the flow of the initial positioning speed increase process.

Initially, the host CPU 420 sends a request signal for compressed long-term prediction ephemeris data to the server system 3 (step D1). Then, the host CPU 420 receives the compressed long-term prediction ephemeris data 353 from the server system 3, and stores the ephemeris data 353 in the flash ROM 480 for update (step D3).

The host CPU 420 performs compressed long-term prediction ephemeris expanding process to restore the compressed data to the complete long-term prediction ephemeris data 481 (steps D5 through D9). Initially, the host CPU 420 obtains the respective satellite position parameters of the GPS satellites SV in the respective unit terms based on the reference orbit data 355 stored in the compressed long-term prediction ephemeris data 353 received in step D3 (step D5).

The host CPU 420 obtains disposition structure parameters and satellite position parameters on the prediction orbits for the respective GPS satellites SV in the respective unit terms by using the respective reference orbit disposition structure parameters stored in the received compressed long-term prediction ephemeris data 353 and satellite position parameters obtained in step D5, and using the compressed values stored in the compressed long-term prediction ephemeris data 353 (step D7).

The host CPU 420 produces the complete long-term prediction ephemeris data 481 containing the disposition structure parameters and the satellite position parameters of the respective GPS satellites SV in the respective unit terms, and stores the complete long-term prediction ephemeris data 481 in the flash ROM 480 for update (step D9). Then, the host CPU 420 ends the initial positioning speed increase process.

Returning to the main process shown in FIG. 21, the host CPU 420 judges whether power OFF command operation has been performed by the user through the operation unit 430 after performing any of the processes in steps C3 through C9 (step C11). When it is judged that the power OFF command operation has not been performed (step C11; NO), the flow returns to step C1. When it is judged that the power OFF command operation has been performed (step C11; YES), the main process ends.

### 5. OPERATION AND ADVANTAGE

According to the positioning system 1, the server system 3 calculates prediction orbits of plural GPS satellites SV moving along predetermined orbits around the earth by using prediction positions of the GPS satellites SV stored in satellite prediction almanac obtained from the external system 2. Then, the server system 3 calculates differences between parameters of the reference orbit as average orbit of the satellites of the plural GPS satellites SV moving along the same orbits and parameters of the prediction orbit of the GPS satellites SV, and stores the differences instead of the prediction orbit parameters to produce compressed long-term prediction ephemeris. Then, the server system 3 sends the compressed long-term prediction ephemeris thus produced to the cellular phone 4 in response to the request from the cellular phone 4.

The GPS satellites SV moving along the predetermined orbits around the earth do not necessarily move along the same orbit without any difference due to disturbance. The GPS satellites SV are only controlled in such a manner as to move along the predetermined orbits around the earth as much as possible. Thus, the actual orbits are slightly different every time the GPS satellites SV move along the orbits. In this case, the data amount of the difference between the data of the reference orbit obtained as the reference of the predetermined orbits around the earth and the data of the prediction orbits along which the GPS satellites SV may actually move is considerably smaller than the data amount of the prediction orbits. Thus, reduction of the communication cost such as communication time and communication volume, and reduction of the memory capacity necessary for data storage can be achieved by providing or storing the difference between the reference orbit data and prediction orbit data instead of the prediction orbit data itself.

The data amount of the long-term prediction ephemeris increases as the period of the data becomes longer. However, the data amount can be reduced by producing the compressed long-term prediction ephemeris containing differences as in this embodiment.

### 6. MODIFIED EXAMPLE

### 6-1. Positioning System

According to this embodiment, the positioning system 1 including the server system 3 and the cellular phone 4 has been discussed. However, the positioning system according to the embodiment of the invention maybe included in an electronic device such as portable-type personal computer, PDA (personal digital assistant), and car navigation device, provided with the positioning device.

While the server system 3 is provided as one type of data compressing device in this embodiment, the data compressing device may be a general-purpose personal computer, for example.

### 6-2. Satellite Positioning System

While the GPS is used as the satellite positioning system in this embodiment, the satellite positioning system may be WAAS (wide area augmentation system), QZSS (quasi zenith satellite system), GLONASS (global navigation satellite system), GALILEO or other satellite positioning systems.

### 6-3. Division of Process

A part or all of the processes performed by the host CPU 420 may be executed by using the CPU 415. For example, the CPU 415 issues a request for compressed long-term prediction ephemeris to the server system 3, and produces complete long-term prediction ephemeris by expanding the compressed long-term prediction ephemeris received from the server system 3 to capture and extract GPS satellite signals. Obviously, the positioning calculation may be performed not by the host CPU 420 but by the CPU 415.

### 6-4. Compressed Long-Term Prediction Ephemeris

According to this embodiment, the server system 3 produces reference orbit data at the time of creation of compressed long-term prediction ephemeris, and produces compressed long-term prediction ephemeris data containing the reference orbit data and compressed prediction ephemeris to be sent to the cellular phone 4. However, the data amount of the compressed long-term prediction ephemeris provided by the server system 3 can be reduced by obtaining the reference orbit data as fixed data from the server system 3 and retaining the reference orbit data in the cellular phone 4 in advance.

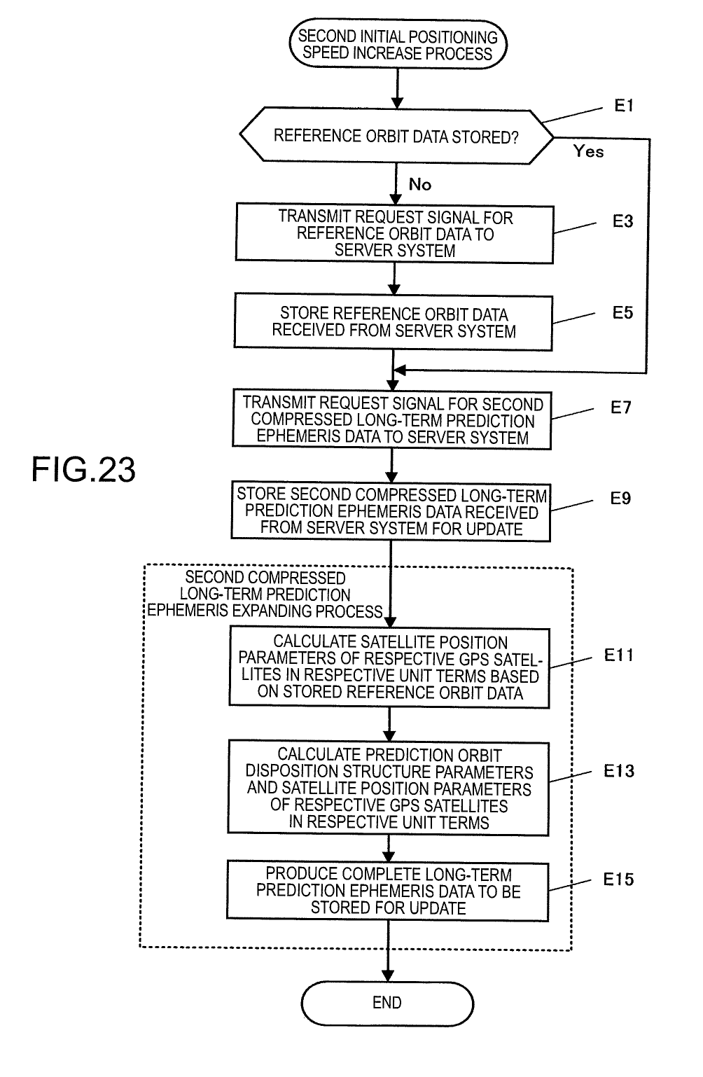

FIG. 23 is a flowchart showing the flow of a second initial positioning speed increase process performed by the cellular phone 4 in this case.

Initially, the host CPU 420 judges whether the reference orbit data 355 has been stored in the flash ROM 480 (step E1). When it is judged that the reference orbit data 355 has been stored (step E1; YES), the flow goes to step E7.

When it is judged that the reference orbit data 355 has not been stored (step E1; NO), the host CPU 420 sends a request signal for the reference orbit data 355 to the server system 3 (step E3). Then, the host CPU 420 receives the reference orbit data 355 from the server system 3 and stores the reference orbit data 355 in the flash ROM 480 (step E5).

Subsequently, the host CPU 420 sends a request signal for second compressed long-term prediction ephemeris to the server system 3 (step E7), and receives second compressed long-term prediction ephemeris data from the server system 3 to store the second compressed long-term prediction ephemeris data in the flash ROM 480 for update (step E9).

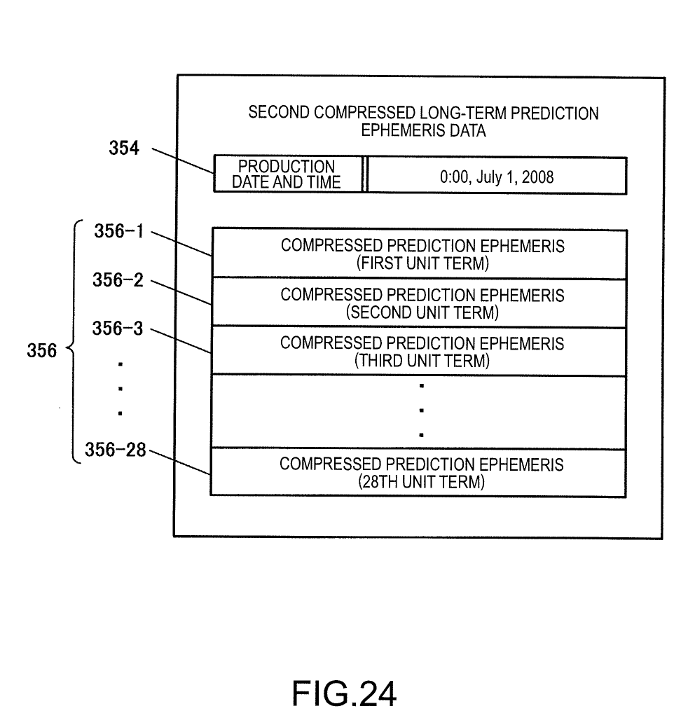

FIG. 24 shows an example of data structure of the second compressed long-term prediction ephemeris data. The second compressed long-term prediction ephemeris data stores the production date and time 354, the compressed prediction ephemeris 356 in first through 28th unit terms (356-1, 356-2, up to 356-28) in association with each other. The difference from the compressed long-term prediction ephemeris data 353 shown in FIG. 10 is that the reference orbit data 355 is not contained.

Returning to the second initial positioning speed increase process shown in FIG. 23, the host CPU 420 performs second compressed long-term prediction ephemeris expanding process to restore the compressed data to the complete long-term prediction ephemeris data 481 after the process in step E9 is completed (steps E11 through E15). More specifically, the host CPU 420 obtains the position parameters of the respective GPS satellites SV in the respective unit terms based on the reference orbit data 355 stored in the flash ROM 480 (step E11).

The host CPU 420 calculates disposition structure parameters and satellite position parameters on the prediction orbits for the respective GPS satellites in the respective unit terms using the respective reference orbit disposition structure parameters stored in the reference data 355 of the flash ROM 480 and the respective satellite position parameters obtained in step E11 and using the compressed values stored in the received second compressed long-term prediction ephemeris data (step E13).

The host CPU 420 produces the complete long-term prediction ephemeris data 481 containing the disposition structure parameters and satellite position parameters calculated for all the GPS satellites SV in all the unit terms, and stores the complete long-term prediction ephemeris data 481 in the flash ROM 480 for update (step E15). Then, the host CPU 420 ends the second initial positioning speed increase process.

In this modified example, the cellular phone 4 receives the reference orbit data from the server system 3 beforehand and retains the reference orbit data. However, the cellular phone 4 may obtain reference orbit data at the time of product shipment with no necessity for receiving the reference orbit data from the server system 3.

### 6-5. Standard Orbit

In the examples described above, the average orbit of the plural same orbit satellites is calculated, and determines the average orbit as the reference orbit (standard orbit) of the corresponding same orbit satellite combination. However, the following method may be employed. First, one satellite is selected from the same orbit satellites. Then, the orbit of the selected satellite is calculated based on the time-series data of the prediction position of the selected satellite by using the minimum square method, for example. The calculated orbit is determined as the reference orbit of the corresponding same orbit satellite combination. That is, the prediction orbit of the selected satellite is determined as the reference orbit. Since the same orbit satellites move along substantially the same orbit, considerably large errors are not produced from the reference orbit calculated based on the prediction position of one satellite selected from the same orbit satellites.

6-6. Calculation of Reference Orbit from Basic Orbit

The reference orbit can be calculated by the following method. The reference orbit of one of the six same orbit satellite combinations is determined as the basic orbit. Then, reference orbits of the other same orbit satellite combinations are calculated by varying the relative angle (inclination angle) of the basic orbit with respect to the earth center. More specifically, the reference orbits of the respective same orbit satellite combinations are calculated by performing predetermined transformation calculation for transforming relative postures for orbit inclination angle, ascending node right-ascension, and perigee argument included in the disposition structure parameters of the basic orbit. According to this method, not plural reference orbits but only one reference orbit (basic orbit) needs to be calculated.

### 6-7. Production and Provision of Compressed Long-Term Prediction Ephemeris

According to the examples described above, the server system 3 produces compressed long-term prediction ephemeris at predetermined time intervals (such as once for every four hours) beforehand, and sends the compressed long-term prediction ephemeris when receiving a request for compressed long-term prediction ephemeris from the cellular phone 4. However, the server system 3 may produce and send compressed long-term prediction ephemeris when receiving the request for compressed long-term prediction ephemeris from the cellular phone 4.

### 6-8. Approximation Model of Satellite Orbit

According to the examples described above, the orbits of the GPS satellites are calculated based on the Kepler's approximation model. However, the orbits may be calculated based on other approximation models such as those of Lagrange, Neville, and Spline. More specifically, the reference orbits and prediction orbits may be calculated by obtaining interpolation polynomial using interpolation technology such as Lagrange, Neville, and Spline methods setting the prediction positions stored in the satellite prediction almanac as sample points for each of the GPS satellites.

### 6-9. Prediction Period

According to the examples described above, compressed long-term prediction ephemeris is produced for one week from the date and time of producing compressed long-term prediction ephemeris as prediction period. However, the prediction period may be a period longer than one week (such as two weeks), or a period shorter than one week (such as three days). The effective period of ephemeris as navigation data transmitted from a GPS satellite is generally about four hours. Long-term prediction ephemeris is only required to have effective period longer than that of ephemeris as navigation data sent from a GPS satellite.

### 6-10. Unit Term

According to the examples described above, the unit term is six hours as a division of the prediction period of the compressed long-term prediction ephemeris. However, the length of the unit term may be variable such as four hours.

What is claimed is:

1. A data compressing method comprising:
calculating prediction orbit data of a plurality of positioning satellites moving along predetermined orbits around the earth by using prediction positions of the plural positioning satellites;
calculating differences between standard orbit data as standard for the predetermined orbits around the earth and the prediction orbit data of the plural positioning satellites; and
storing the differences.

2. The data compressing method according to claim 1, wherein:
the predetermined orbits around the earth contain a plurality of orbits having different inclination angles with respect to the earth, along which orbits the plural positioning satellites move; and
the data compressing method further includes calculating the standard orbit data of the plural orbits based on one basic orbit of the plural orbits and the inclination angles.

3. The data compressing method according to claim 1, further comprising:
calculating reference orbit data of the plural positioning satellites based on the prediction positions of the plural positioning satellites,
wherein the differences are calculated using the reference orbit data as the standard orbit data.

4. The data compressing method according to claim 1, wherein:
the prediction orbit data is calculated for each of predetermined unit terms;
the differences are calculated for each of the predetermined unit terms; and
the differences are stored using substitute data containing the differences of the plural positioning satellites for each of the predetermined unit terms instead of long-term satellite orbit almanac data containing the prediction orbit data of the plural positioning satellites for each of the predetermined unit terms.

5. A data providing method which provides the substitute data calculated by the data compressing method according to claim 4 instead of the long-term satellite orbit almanac data.

6. A data compressing device, comprising:
a prediction orbit data calculating unit which calculates prediction orbit data of a plurality of positioning satellites moving along predetermined orbits around the earth by using prediction positions of the plural positioning satellites;
a difference calculating unit which calculates differences between standard orbit data as standard for the predetermined orbits around the earth and the prediction orbit data of the plural positioning satellites; and
a difference storing unit which stores the differences.
